(19) United States
(12) Patent Application Publication
(10) Pub. No.: US 2018/0025306 A1
(43) Pub. Date: Jan. 25, 2018

(54) AUTOMATED AGILE ROADMAP DECISION MANAGEMENT SYSTEM

(71) Applicant: INTERNATIONAL BUSINESS MACHINES CORPORATION, Armonk, NY (US)

(72) Inventors: Flora BATCA, Raleigh, NC (US); Steven L. BRAZIL, Gilroy, CA (US); Paul K. BULLIS, Cedar Park, TX (US); Geoffrey M. HAMBRICK, Round Rock, TX (US); Mark A. PARZYGNAT, Raleigh, NC (US)

(21) Appl. No.: 15/214,696

(22) Filed: Jul. 20, 2016

(51) Int. Cl. G06Q 10/06

(52) U.S. Cl. CPC G06Q 10/06315

(57) ABSTRACT

Systems and methods for managing allocation of resources among plural offerings of an enterprise are disclosed. A method includes: maintaining, by a computer device, a ranked list of the offerings, wherein the ranked list is viewable at plural user devices within the enterprise; receiving, by the computer device, an input to link an item to one of the offerings included in the ranked list; accessing, by the computer device, stored cost/benefit data defined for the item, wherein the accessing comprises using an application programming interface (API) call; updating, by the computer device, a score of the one of the offerings based on the cost/benefit data defined for the item; updating, by the computer device, the ranked list based on the updated score.

### BACKGROUND

The present invention generally relates to decision management tools and, more particularly, to a system and method for managing allocation of resources among a plurality of offerings in order to determine a priority of development of the offerings.

In an enterprise development environment such as a product organization, requests for offerings (e.g., features, functions, serviceability items, etc.) compete for the same development resources constantly throughout development iterations. A decision analysis tool may be used by in an enterprise development environment to collect information and feedback from internal and external stakeholders on the value of applications and technologies and their features, prioritize which ones will provide the most value to the business, and manage how improved products will be fielded or removed from market or organization. However, current systems do not prioritize based on actual cost and revenue of the items requested.

### SUMMARY

In a first aspect of the invention, there is a method for managing allocation of resources among plural offerings of an enterprise. The method includes: maintaining, by a computer device, a ranked list of the offerings, wherein the ranked list is viewable at plural user devices within the enterprise; receiving, by the computer device, an input to link an item to one of the offerings included in the ranked list; accessing, by the computer device, stored cost/benefit data defined for the item, wherein the accessing comprises using an application programming interface (API) call; updating, by the computer device, a score of the one of the offerings based on the cost/benefit data defined for the item; updating, by the computer device, the ranked list based on the updated score.

In another aspect of the invention, there is a system for managing allocation of resources among plural offerings in order to determine a priority of development of the offerings. The system includes: a CPU, a computer readable memory and a computer readable storage medium associated with a computing device; program instructions to maintain a ranked list of the offerings, wherein the ranked list is viewable at plural user devices within the enterprise, and the offerings comprise at least one selected from the group consisting of: sales offerings; service offerings; and serviceability offerings; program instructions to receive an input, from one of the user devices, to link an item to one of the offerings included in the ranked list; program instructions to access stored cost/benefit data defined for the item; program instructions to update a score of the one of the offerings based on the cost/benefit data defined for the item; and program instructions to update the ranked list based on the updated score. The program instructions are stored on the computer readable storage medium for execution by the CPU via the computer readable memory.

In another aspect of the invention, there is a computer program product for managing allocation of resources among plural offerings in order to determine a priority of development of the offerings. The computer program product includes a computer readable storage medium having program instructions embodied therewith. The program instructions are executable by a computing device to cause the computing device to: maintain a ranked list of the offerings, wherein the ranked list is viewable at plural user devices within the enterprise, and the offerings comprise at least one selected from the group consisting of: sales offerings; service offerings; and serviceability offerings; link an item to one of the offerings included in the ranked list, wherein the item is one of: a sales item; a service item; and a serviceability item; access stored data defined for the item; update a score of the one of the offerings based on the data defined for the item; update the ranked list based on the updated score; and transmit data defining the updated ranked list to one of the plural user devices.

### BRIEF DESCRIPTION OF THE DRAWINGS

The present invention is described in the detailed description which follows, in reference to the noted plurality of drawings by way of non-limiting examples of exemplary embodiments of the present invention.

FIG. 1 depicts a computing infrastructure according to an embodiment of the present invention.

FIG. 2 shows a block diagram of an exemplary environment in accordance with aspects of the invention.

FIG. 3A shows a functional block diagram in accordance with aspects of the invention.

FIG. 3B shows an exemplary graph of amortized scores for offerings in accordance with aspects of the invention.

FIG. 4 shows a flowchart of a method in accordance with aspects of the invention.

### DETAILED DESCRIPTION

The present invention generally relates to decision management tools and, more particularly, to systems and methods for managing allocation of resources among a plurality of offerings in order to determine a priority of development of the offerings. Systems and methods in accordance with aspects of the invention create an agile roadmap that includes a ranked list of offerings across an enterprise. In embodiments, a score (e.g., a monetary score) is determined for each offering using cost/benefit data associated with items that are linked to the respective offerings. The score for a particular offering may change when additional cost/benefit data is input for items that are already linked to the offering, or when a new item with new cost/benefit data is linked to the offering. In this manner, the score for each offering may be updated in real time as new cost/benefit data is provided, and the ranked list may likewise be updated in real time according to the updated scores of the various offerings. The ranked list of offerings may be used by the enterprise in the decision making process of determining the most promising offerings (e.g., in monetary terms of return on investment) for which to allocate development resources.

Aspects of the invention are directed to creating an agile roadmap that indicates which offering is the optimal next offering for investing development resources in an agile environment through all iterations and based on dollar amounts. Offerings may include, but are not limited to, sales offerings, service offerings, and serviceability offerings. Sales offerings may include, for example, new products or features for sale by the enterprise. Service offerings may include, for example, new services for sale by the enterprise. Serviceability offerings may include, for example, improvements to warranty services provided by the enterprise.

Implementations of the invention avoid the problem of serviceability offerings being considered only very late in the decision making process, compared to sales offerings and service offerings, or being ignored altogether. In embodiments, this is accomplished by including serviceability offerings in the ranked list with other offerings (e.g., sales offerings and/or service offerings) and updating the ranked list in real time as new cost/benefit data is provided for any offering. The cost/benefit data used to determine the score of each offering may include at least one selected from the group consisting of: development cost; testing cost; delivery cost; servicing (warranty) cost; post-sale debugging cost; revenue of the offering; usable life of the offering; discounts (e.g., down payment costs); and ancillary business benefits associated with the offering. The cost/benefit data may include actual costs and/or benefits. The cost benefit data may also include estimated costs and/or benefits. Different algorithms may be used with the cost/benefit data to generate the scores for different types of offerings. The scores for the various offerings may be amortized over a period of time to determine a true cost for each offering over a next agile iteration.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

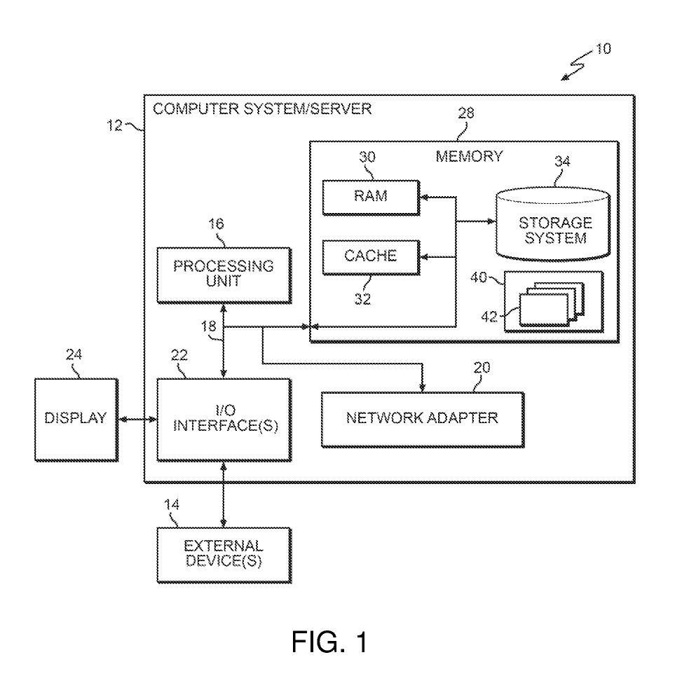

Referring now to FIG. 1, a schematic of an example of a computing infrastructure is shown. Computing infrastructure 10 is only one example of a suitable computing infrastructure and is not intended to suggest any limitation as to the scope of use or functionality of embodiments of the invention described herein. Regardless, computing infrastructure 10 is capable of being implemented and/or performing any of the functionality set forth hereinabove.

In computing infrastructure 10 there is a computer system (or server) 12, which is operational with numerous other general purpose or special purpose computing system environments or configurations. Examples of well-known computing systems, environments, and/or configurations that may be suitable for use with computer system 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system 12 may be described in the general context of computer system executable instructions, such as program modules, being executed by a computer system. Generally, program modules may include routines, programs, objects, components, logic, data structures, and so on that perform particular tasks or implement particular abstract data types. Computer system 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system 12 in computing infrastructure 10 is shown in the form of a general-purpose computing device. The components of computer system 12 may include, but are not limited to, one or more processors or processing units (e.g., CPU) 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 12 typically includes a variety of computer system readable media. Such media may be any available media that is accessible by computer system 12, and it includes both volatile and non-volatile media, removable and non-removable media.

System memory 28 can include computer system readable media in the form of volatile memory, such as random access memory (RAM) 30 and/or cache memory 32. Computer system 12 may further include other removable/non-removable, volatile/non-volatile computer system storage media. By way of example only, storage system 34 can be provided for reading from and writing to a nonremovable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system 12 may also communicate with one or more external devices 14 such as a keyboard, a pointing device, a display 24, etc.; one or more devices that enable a user to interact with computer system 12; and/or any devices (e.g., network card, modem, etc.) that enable computer system 12 to communicate with one or more other computing devices. Such communication can occur via Input/Output (I/O) interfaces 22. Still yet, computer system 12 can communicate with one or more networks such as a local area network (LAN), a general wide area network (WAN), and/or a public network (e.g., the Internet) via network adapter 20. As depicted, network adapter 20 communicates with the other components of computer system 12 via bus 18. It should be understood that although not shown, other hardware and/or software components could be used in conjunction with computer system 12. Examples, include, but are not limited to: microcode, device drivers, redundant processing units, external disk drive arrays, RAID systems, tape drives, and data archival storage systems, etc.

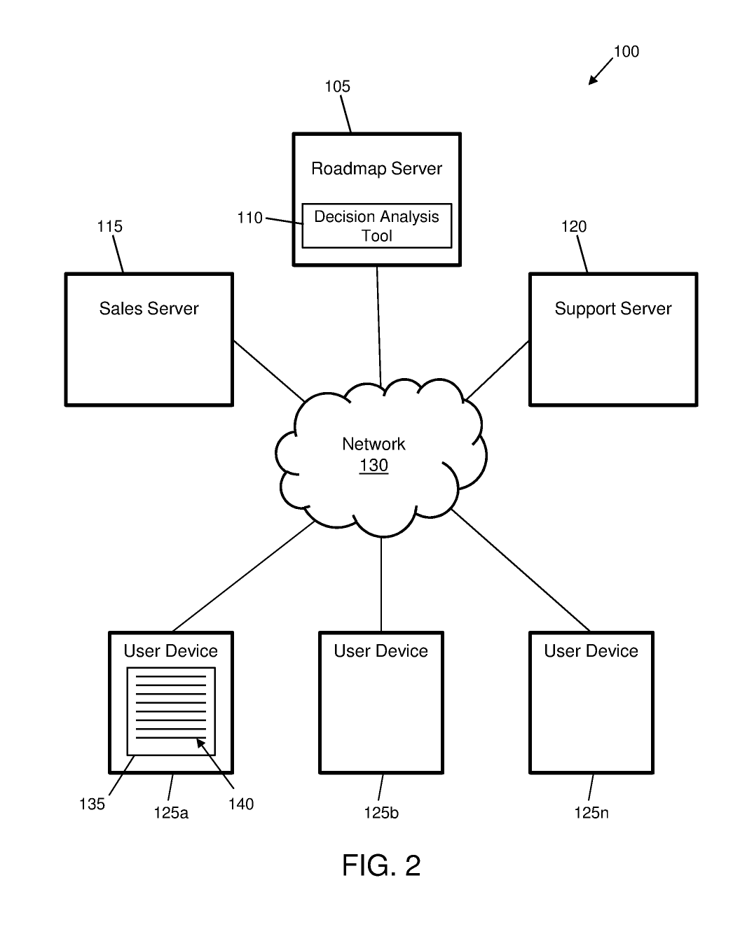

FIG. 2 shows a block diagram of an exemplary the environment 100 in accordance with aspects of the invention. In embodiments, the environment 100 includes a roadmap server 105 that runs a decision analysis tool 110. The roadmap server 105 may be a computer system 12 and the decision analysis tool 110 may be a program module 42 described with respect to FIG. 1. In embodiments, the roadmap server 105 running the decision analysis tool 110 may perform one or more of the functions described herein, including: obtaining cost/benefit data about each offering; generating a score (e.g., monetary score) for each offering based on the cost/benefit data; generating a list of the offerings ranked according to score; and updating one or more scores and the list in real time as new cost/benefit data is obtained.

In embodiments, the environment 100 also includes a sales server 115 and a support server 120. Each server 115, 120 may include elements of the computer system 12 of FIG. 1, such as processor 16, memory 28, and program/utility 40. In embodiments, the sales server 115 is an enterprise computer system that manages sales data received from one or more user devices 125a, 125b, . . . , 125n, and the support server 120 is an enterprise computer system that manages support data received from one or more of the user devices 125a, 125b, . . . , 125n.

For example, an enterprise user may input sales data into their user device 125a, and that sales data may be communicated from the user device 125a to the sales server 115, and stored at the sales server 115 (e.g., in a searchable database). The sales data may be any desired data associated with a new sales item, including but not limited to: item identifier; development cost of the item; testing cost of the item; delivery cost of the item; post-sale debugging cost of the item; revenue of the item; usable life of the item; and ancillary business benefits associated with the item. An example of a sales item is a new software program that is requested by a client of the enterprise, and may include data such as: software program identifier; hours to develop the software program; and sales revenue of the software program. This data may be stored in a searchable database of the sales server 115. Aspects of the invention are not limited to this example, and other types of sales items and other types of sales data may be used.

Similarly, an enterprise user may input support data into their user device 125b, and that support data may be communicated from the user device 125b to the support server 120, and stored at the support server 120 (e.g., in a searchable database). The support data may be any desired data associated with a new support item, including but not limited to: support item identifier; servicing (warranty) cost of the item; and estimated savings produced by the item. An example of a support item is a problem ticket generated by a support team of the enterprise when providing warranty service for a client of the enterprise, and may include data such as: problem ticket identifier; type of problem reported by the client; and number of hours spent by the support team working on the problem for the client. This data may be stored in a searchable database of the support server 120. Aspects of the invention are not limited to this example, and other types of support items and other types of support data may be used.

Still referring to FIG. 2, there may be any desired number “n” of user devices 125a-n. The user devices that provide data to the sales server 115 and the user devices that provide data to the support server 120 need not be mutually exclusive, as it is possible that some enterprise users will be involved with both sales items and support items. In embodiments, the sales server 115 stores sales data for plural different sales items, and the support server 120 stores support data for plural different support items. Moreover, implementations of the invention are not limited to separate servers for the sales server 115 and the support server 120. For example, the functionality of the sales server 115 and the support server 120, as described herein, may be combined into a single server that is accessible by all the user devices 125a-n. In another exemplary implementation, the roadmap server 105, the sales server 115, and the support server 120 can be combined into a single server or system.

As shown in FIG. 2, all the devices of the environment 100 may be connected to a communication network 130 that supports computer-based communication between computer devices. The network 130 may be any desired network or combination of networks, including but not limited to: LAN, WAN, and the Internet. The computer devices of the environment 100 may communicate with one another using, for example, application programming interface (API) calls. Specifically, the user devices 125a-n may provide data to and/or access data from the sales server 115 using an API call that is specific to a program running on the sales server 115. The user devices 125a-n may also provide data to and/or access data from the support server 120 using an API call that is specific to a program running on the support server 120. The user devices 125a-n may also provide data to and/or access data from the roadmap server 105 using an API call that is specific a program running on to the roadmap server 105. Similarly, the roadmap server 105 and may access data from the sales server 115 using an API call that is specific to a program running on the sales server 115, and may access data from the support server 120 using an API call that is specific to a program running on the support server 120.

In accordance with aspects of the invention, the roadmap server 105 running the decision analysis tool 110 is configured to create an agile roadmap that includes a ranked list of offerings across the enterprise. Each offering in the ranked list is linked with at least one sales item stored in the sales server 115 or at least one support item stored in the support server 120. In embodiments, the decision analysis tool 110 generates a score (e.g., a monetary score) for each offering in the ranked list using the sales data or support data of the item(s) that are linked with each respective offering. The decision analysis tool 110 may be programmed with algorithms to determine a respective score for each offering using the data from the servers 115, 120. For example, the decision analysis tool 110 may be programmed with one or more algorithms that are used to determine a score for a sales offering using data from linked sales items stored in the sales server 115. Similarly, the decision analysis tool 110 may be programmed with one or more algorithms that are used to determine a score for a new serviceability offering using data from linked support items stored in the support server 120. The algorithm(s) used by the decision analysis tool 110 may be customized based on the types of data stored in the servers 115, 120, e.g., such that values from data fields stored in the servers 115, 120 are input as variables in the algorithm(s) for determining a score of an offering.

In embodiments, items stored in the servers 115, 120 are linked to offerings of the ranked list by user input. For example, an enterprise user may use their user device 125a to access the roadmap server 105 to view the ranked list of offerings. Using an interface 135 displayed on the user device 125a, the enterprise user may view the ranked list 140 of offerings and provide input that links a particular item (e.g., a sales item or a support item) to a particular offering that is included in the list. For example, the user device 125a may make a first API call to the roadmap server 105 to view the ranked list of offerings, and may make a second API call to the roadmap server 105 to link an item to an offering in the ranked list based upon receiving input from a user.

In accordance with aspects of the invention, the score of an offering in the ranked list is updated when a user links an item to the offering. In embodiments, the decision analysis tool 110 obtains the data associated with the linked item from the sales server 115 or the support server 120, and updates the score for the offering based on this data. For example, upon receiving input to link a sales item to an offering, the decision analysis tool 110 may make an API call to the sales server 115 to obtain the sales data associated with the sales item, aggregate this sales data with the sales data that was previously used to determine the score for the offering, and determine an updated score for the offering based on the aggregated data. Moreover, different enterprise users may link different items to a same offering. In this manner, there may be plural items linked to a single offering, and the score of the offering is based on the cost/benefit data (e.g., the sales data or the support data) associated with all the linked items.

In this manner, the score for each offering may be updated in real time when an item is linked to the offering. The ranked list of offerings may also be updated based on the score for an offering being updated. For example, since the offerings are ranked by score, the act of updating a score for an offering may causes a change in the rankings. In this manner, the ranked list of offerings may be updated in real time when an item is linked to an offering. Employees across the enterprise can provide input to the decision analysis tool 110 to link items to offerings independent of what items other employees are linking to offerings. In this manner, the ranked list of offerings may be determined based on input from plural different sources (e.g., different enterprise users), and may be automatically updated based on receiving input from any one of the sources. The ranked list of offerings may be used by the enterprise in the decision making process of determining the most promising offerings (e.g., in monetary terms of return on investment) for which to allocate development resources.

In embodiments, alternatively to linking an item to an existing offering, an enterprise user may provide input to create an offering based on the item. For example, upon viewing the ranked list of offerings, the enterprise user may decide that an item (e.g., a support) item does not correspond to any of the currently existing offerings. In this case, the enterprise user may provide input to their user device 125a to request to the decision analysis tool 110 that an offering be created for this item. In embodiments, the request is reviewed by an evaluation team which determines whether the item will be used to make an offering. On the one hand, the evaluation team may determine that the requested item is not sufficiently defined to support an offering, in which case the requesting user is instructed to obtain more data about the item and resubmit the request. On the other hand, the evaluation team may agree with the enterprise user's request and provide input to the decision analysis tool 110 to modify the ranked list by creating and adding an offering to the ranked list. A score for the offering would be determined based on the data associated with the item that was the subject of the request for an offering. At this point, the newly created offering would appear in the ranked list, and other users would be able to link other items to this particular offering, thereby causing the score of the offering to be updated and potentially causing the order of offerings in the ranked list to be changed.

In embodiments, the evaluation team may also be tasked with making a determination as to whether an item is sufficiently defined prior to linking that item to an existing offering. For example, when an enterprise user provides input to link an item to an offering in the ranked list, the evaluation team may review the item and approve or reject the request to link the item to the offering. Reasons for rejection may be, for example, that the data for the item is not adequately defined for use by the algorithm(s) used by the decision analysis tool 110. Some of the functions of the evaluation team as described herein may be automated via appropriate programming in the decision analysis tool 110. For example, the decision analysis tool 110 may be programmed with rules that automatically analyze a request to link an item to an offering and approve or reject the request based on the analysis. As another example, the decision analysis tool 110 may be programmed with rules that automatically analyze a request to create an offering and approve or reject the request based on the analysis.

A first exemplary use case for illustrating aspects of the invention involves an enterprise user that works in the sales group of the enterprise organization. The user communicates with a group of customers and determines from customer input that a software enhancement is desired in the market. The user analyzes the software enhancement and determines that the enterprise could sell the software enhancement immediately to three customers resulting in a particular estimated revenue over a time period. The user provides input to a user device 125a to define sales data of a sales item for the software enhancement in the database of the sales server 115. The sales item for the software enhancement is sent to an evaluation team that analyzes its merit. Based on the analysis, the evaluation team preforms one of: returns the sales item to the user to obtain more sales data; links the sales item to an offering already in the ranked list; and creates an offering based on the sales item. In the event the sales item is linked to an existing offering, then the decision analysis tool 110 updates the score of that offering based on the sales data associated with the sales item, and may update the ranked list based on the updated score. In the event an offering is created based on this sales item, then the decision analysis tool 110 determines a score for the offering based on the sales data of the sales item, and may update the ranked list based on the newly added offering and its score.

Implementations have been described thus far with respect to a user providing input to link an item (e.g., a sales item or a support item) to an offering (e.g., a sales offering or a support offering). In embodiments, the determination to link an item to an offering may be made automatically by the system by applying matching rules that determine when an item is related to an offering. The matching rules may be programmed into the decision analysis tool 110 and may operate based on matching classification codes or categories that are assigned to each of the items and offerings. For example, when an enterprise user enters support data for a support item (e.g., a problem ticket), the system may prompt the enterprise user to select a classification code or category from a predefined list of classification codes or categories. The system may then use the assigned classification code or category for the support item to search for existing offerings having the same classification code or category, and may be programmed to link the support item to any such offerings having the same classification code or category.

The automated linking of an item to an offering is illustrated by a second exemplary use case that involves an enterprise user (e.g., a support engineer) that works in the support group of the enterprise organization. In this example, a client of the enterprise finds that an error log has a confusing error message and opens a problem ticket with the support group. The support engineer is assigned to the problem ticket and spends seven hours helping the client resolve the issue of the confusing error message. The support engineer opens a recommendation (e.g., creates an offering) targeting the development team to improve the error message to make it more clear what the error is and how to respond to it. The system then operates to: link the current problem ticket to the offering; compute the potential value of the offering in part by the cost of the warranty for the seven hours; search for existing problem tickets associated with the same error message, discovering that there have been five similar problem tickets a month for the past year for this same confusing error message; link the identified problem tickets associated with this particular error message to the recommendation (e.g., offering); update the potential value (e.g., score) of the recommendation based on the data associated with the newly linked problem tickets; optionally compute a return on investment using an estimate of the implementation cost of the recommendation; optionally alert the target team in the event the computed return on investment exceeds a predefined threshold value for identifying promising recommendations.

Still referring to the second exemplary use case, as new problem tickets are opened, the system automatically operates to: search for recommendations associated with the same classification code or category of task of the problem ticket; link a problem ticket to a recommendation based on both having the same category of task; update a score of a recommendation when a problem ticket is linked to the recommendation; optionally update a return on investment using an estimate of the implementation cost of the recommendation; and optionally alert the target team in the event the computed return on investment exceeds a predefined threshold value for identifying promising recommendations. As soon as recommendations (e.g., offerings) are created or updated, and regardless of whether a notification is sent to the target team, the development team can use the system to: see the new recommendation prioritized with other recommendations of the target team; select one recommendation for implementation and enter the actual cost of implementation; alert the team that the recommendation has been implemented; and compute actual savings (or extra revenue/profit) associated with the tasks in the same category as those linked to the recommendation in part based on changes to: an arrival rate (if the task generates revenue it is desired to have more, and if the task represents a cost it is desired to have less); the duration of the task (it is often preferred to minimize the duration); and the effort the task requires (it is often preferred to expend less effort).

Implementations of the invention have been described thus far with respect to sales items, support items, sales offerings, and support offerings. Embodiments of the invention are not limited to these examples, and instead any types of items and offerings may be used, e.g., depending on the arrangement of the enterprise.

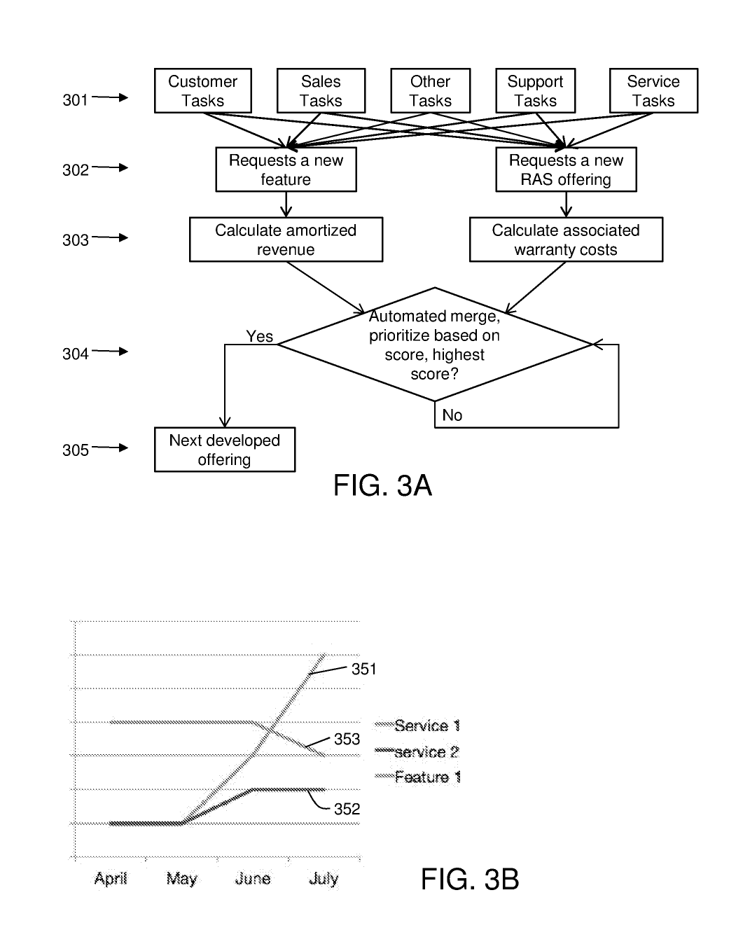

FIG. 3A shows a functional block diagram in accordance with aspects of the invention. As shown in FIG. 3A, level 301 depicts tasks that are performed by customers and/or enterprise users (e.g., members of a sales team, support team services team, etc.). The tasks may correspond to items as described with respect to FIG. 2, and data defining each task may be input and saved in the system for example as sales data, support data, etc. The “Other Tasks” box includes tasks that are not categorized as any of Customer, Sales, Support and Service, such as tasks resulting from public impacts, e.g., in regards to open source community members, as but one example. Level 302 depicts requesting new offerings based on the tasks. The offerings may comprise, for example, sales offerings such as a new feature, or support offerings such as a RAS (reliability, availability, serviceability) offering. Level 303 depicts calculating a score for each offering, and corresponds to the decision analysis tool 110 determining a score of an offering based on the cost/benefit data (e.g., sales data associated with sales items linked to the offering, support data associated with support items linked to the offering, etc.). Level 304 depicts generating a ranked list of offerings, and may include merging data from plural items in determining a score for an offering. Level 305 depicts the highest ranked offering being selected as the next developed offering in the enterprise.

According to additional aspects of the invention, the respective scores for offerings may be amortized based on certain cost/benefit data (e.g., sales data and support data) associated with items linked to the offerings. FIG. 3B shows an exemplary graph of calculated scores 351, 352, 353 of three offerings (Service1, Service2, Feature1) amortized over a period of time (e.g., from April to July). The scores 351, 352, 353 may be determined in the manner described herein. Based on such a graph, the enterprise may decide to invest first in the Service1 offering prior to June, as this offering will overtake the Feature1 at that time.

As illustrated in the graph in FIG. 3B, it is common for the score of serviceability offerings to include a period of increase over time. This increase may put sales offerings at a lower priority in the ranked list. To account for this, in embodiments, the sales data for sales items associated with a sales offering my include discounts (e.g., down payment costs) that are offered by the sales team to bring more money to the front of the agile development iteration, offering a small discount for the up-front payment. This upfront cost may temporarily counter the incline of support offerings to get the sales offering higher in the ranked list.

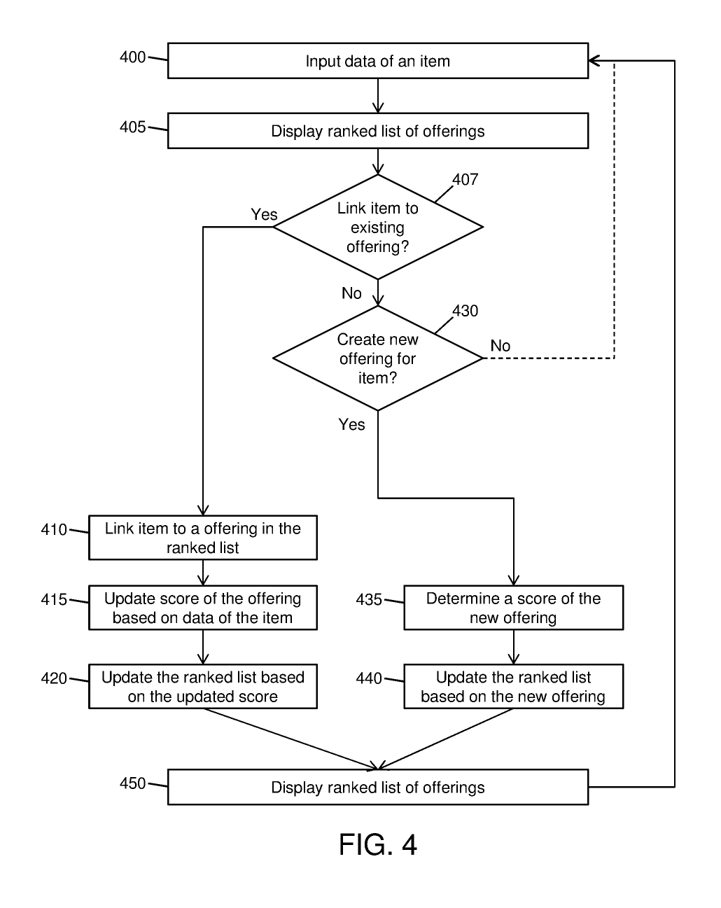

FIG. 4 depicts a method of generating an agile roadmap in accordance with aspects of the invention. The steps of the method may be performed in the environment of FIG. 2 and are described with reference to the elements described in FIG. 2.

Referring to FIG. 4, at step 400, data for an item is input into the system. Step 400 may be performed in the manner described with respect to FIG. 2, e.g., by an enterprise user providing inputting the data to a user device 125a, and the user device 125a transmitting the data to a data server (e.g., sales server 115 or support server 120). In one example, the item may comprise a sales item and the data may comprise sales data including but not limited to at least one of: item identifier; development cost of the item; testing cost of the item; delivery cost of the item; post-sale debugging cost of the item; revenue of the item; usable life of the item; and ancillary business benefits associated with the item. In another example, the item may comprise a support item and the data may comprise support data including but not limited to at least one of: support item identifier; servicing (warranty) cost of the item; and estimated savings produced by the item.

At step 405, a ranked list of offerings is displayed. The ranked list may be generated by a decision analysis tool 110 running in a roadmap server 105 as described with respect to FIG. 2. The ranked list may sort the offerings according to a score (e.g., a monetary score) for each offering. The ranked list may include offerings from different teams of the enterprise, such as sales offerings, support (serviceability) offerings, and service offerings. The score for each offering may be determined based on cost/benefit data for each offering in the manner described herein, and may take into account amortized revenue (for sales offerings) and warranty costs (for support offerings). The ranked list may be displayed on a user device 125a. For example, the decision analysis tool 110 may receive a request for the ranked list from a user device 125a (e.g., via an API call), and may transmit data defining the ranked list to the requesting user device 125a.

At step 407, a determination is made whether to link the item (from step 400) to an offering that currently exists in the ranked list (from step 405). For example, a user may peruse the ranked list and determine that the item sufficiently corresponds to an offering in the ranked list. The determination may also be made automatically, e.g., by the decision analysis tool 110, as described herein.

In the event the determination at step 407 is Yes, then at step 410, the item (from step 400) is linked to an offering contained in the ranked list (from step 405). In the manual implementation of steps 407 and 410, the user provides input to their user device 125a to link the item to one of the offerings contained in the ranked list of offerings. For example, each offering displayed in the list may include a selectable input field, e.g., a button displayed on a user interface that is selectable by the user to link to the item to the offering. In embodiments, upon receipt of this input from the user, the user device 125a transmits a message to the decision analysis tool 110 indicating the user-defined linking, and the decision analysis tool 110 updates a database of offerings and linked items to include the user-defined linking of this item to the selected offering. Optionally, an evaluation team may analyze a manual request to link an item to an offering, and may authorize the link or may reject the link and return the request to the user for more information.

In the automated implementation of steps 407 and 410, the decision analysis tool 110 automatically links the item to an offering based on classification or category data associated with the item and the offering. This may be performed in the manner described with respect to FIG. 2. For example, the data of the item may include a classification or category of the item, and the decision analysis tool 110 may search all the offerings in the ranked list for matching a classification or category. When the decision analysis tool 110 identifies an offering in the ranked list having a same classification or category as the item, then the decision analysis tool 110 may automatically link the item to that offering.

At step 415, the decision analysis tool 110 updates the score of the offering based on the data of the item that was linked to the offering at step 410. In embodiments, the decision analysis tool 110 accesses one of the data servers (e.g., sales server 115 or support server 120) to obtain the data associated with the linked item. This may be performed, for example, by the decision analysis tool 110 using an API call to one of the sales server 115 and the support server 120 to obtain the data (e.g., the sales data or the support data associated with the item). Upon receiving the data, the decision analysis tool 110 aggregates the received data with any already existing data associated with this offering (e.g., sales data or support data from other items already linked to this offering), and recalculates the score for the offering based on the aggregated data. This may be performed in the manner described with respect to FIG. 2.

At step 420, the decision analysis tool 110 updates the ranked list of offerings based on the updated score from step 415. Step 420 may be performed in the manner described with respect to FIG. 2. After updating the ranked list, the process returns to step 405 to display the ranked list. Plural different enterprise users can, independently of one another, provide input to the decision analysis tool 110 to input data of an item (step 400) and link an item to an offering (step 410). The decision analysis tool 110 may automatically update the scores (step 415) and update the ranked list (step 420) in real time based on the different input from the plural enterprise users.

Referring back to step 407, when it is determined to not link the item (from step 400) to an offering that currently exists in the ranked list, then at step 430 a determination is made whether to create a new offering for the item. In embodiments, an evaluation team analyzes the item and determines whether a new offering is warranted. In the event that it is determined at step 430 to not create a new offering (i.e., “No”), then the process returns to step 400 where the user can input more data for the item. This may be the situation when the evaluation team requests further information from the user that created the item.

In the event that it is determined at step 430 to create a new offering (i.e., “Yes”), then at step 435 the decision analysis tool 110 determines the score of the offering. In embodiments, the decision analysis tool 110 automatically links the item to the newly created offering and accesses one of the data servers (e.g., sales server 115 or support server 120) to obtain the data associated with the linked item. This may be performed, for example, by the decision analysis tool 110 using an API call to one of the sales server 115 and the support server 120 to obtain the data (e.g., the sales data or the support data associated with the item). Upon receiving the data, the decision analysis tool 110 calculates the score for the newly created offering based on the data. This may be performed in the manner described with respect to FIG. 2.

At step 440, the decision analysis tool 110 updates the ranked list to include the new offering and score from step 435. Step 515 may be performed in a manner similar to step 420.

At step 450, after either step 420 or 440, the decision analysis tool 110 displays the updated ranked list. In this manner all users can see any changes to the ranked list, i.e., either from an updated score of a previously existing offering (step 420) or from a new offering being added to the list (step 440). The process then returns to step 400 where the same user or other user may provide data for another item. In this manner, the ranked list of offering may be modified by any user in the enterprise, and the results of the modification can be seen by all other users in the enterprise when they view the ranked list.

In another aspect of the invention, the environment of FIG. 2 may be used to perform a method for managing allocation of financial (monetary) resources among a plurality of offerings (products, services, expanded warranties, etc.) sold by a company in order to determine which new offerings should be developed, the method comprising: creating an algorithm that models the life cycle cost and benefits of offerings, wherein the algorithm includes as input variables: the development cost, testing cost, delivery cost, servicing (warranty costs), post-sale debugging costs (“costs”) associated with an offering, and revenue of the offering, usable life of the offering, ancillary business benefits (“benefits”) associated with the offering; receiving a first request from one business unit of the company to develop a new product offering; applying the algorithm to the new offering; receiving a second request from a second business unit to expand a warranty on an existing line of product offerings; applying the algorithm to the expanded warranty; determining, based on the applications of the algorithm, that the expanded warranty is more valuable than the new product offering (or vice versa); and investing financial resources of the company into the expanded warranty rather than the new product offering (or vice versa).

The method may further include: notifying the first business unit that the new product offering has been rejected, and providing in the notice (i) a statement of the monetary shortfall of the new product offering predicted by the algorithm and (ii) an option for the first business unit to cover the monetary short fall from their portion of financial resources; receiving a response from the first business unit indicating desire to cover the shortfall; investing the combined financial resources in the new product offering to allow development thereof in addition to the expanded warranty.

The method may further include: maintaining a ranked list of potential new offerings and warranties that are sorted based on algorithm score; selecting for investment the highest ranking items on the list at the time of selection; and reselecting a new item that comes on the list at a higher rank if development has not already begun on the previously selected item.

In embodiments, a service provider, such as a Solution Integrator, could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for managing allocation of resources among plural offerings of an enterprise, the method comprising:
maintaining, by a computer device, a ranked list of the offerings, wherein the ranked list is viewable at plural user devices within the enterprise;
receiving, by the computer device, an input to link an item to one of the offerings included in the ranked list;
accessing, by the computer device, stored cost/benefit data defined for the item, wherein the accessing comprises using an application programming interface (API) call;
updating, by the computer device, a score of the one of the offerings based on the cost/benefit data defined for the item;
updating, by the computer device, the ranked list based on the updated score.

2. The method of claim 1, wherein the offerings comprise at least one selected from the group consisting of: sales offerings; service offerings; and serviceability offerings.

3. The method of claim 1, wherein the cost/benefit data includes at least one selected from the group consisting of: development cost; testing cost; delivery cost; servicing/warranty cost; post-sale debugging cost; revenue; usable life; discounts; and ancillary business benefits.

4. The method of claim 1, further comprising:
receiving input to create a new offering;
determining a score of the new offering based on cost/benefit data of at least one item; and
updating the ranked list to include the new offering.

5. The method of claim 1, further comprising:
automatically identifying an additional item to link to the one of the offerings based on a classification code or category;
accessing stored cost/benefit data defined for the additional item;
updating the score of the one of the offerings based on the cost/benefit data defined for the additional item; and
updating the ranked list based on the updating the score of the one of the offerings based on the cost/benefit data defined for the additional item.

6. The method of claim 1, wherein:
the computer device comprises a server running a decision analysis tool; and
the server running the decision analysis tool receives the input to link the item to the offering from one of the user devices within the enterprise.

7. The method of claim 6, wherein the input is received via a user interface of the one of the user devices that displays the ranked list of offerings.

8. The method of claim 6, wherein the input is received via an API call from the one of the user devices to the server running the decision analysis tool.

9. The method of claim 6, further comprising transmitting data defining the updated ranked list to all the plural user devices within the enterprise.

10. The method of claim 1, further comprising receiving the cost/benefit data defined for the item from the one of the user devices.

11. The method of claim 1, wherein the updating the score comprises:
aggregating the accessed cost/benefit data defined for the item with other data already associated with the one of the offerings; and
calculating the updated score using the aggregated data.

12. A system for managing allocation of resources among plural offerings in order to determine a priority of development of the offerings, the system comprising:
a CPU, a computer readable memory and a computer readable storage medium associated with a computing device;
program instructions to maintain a ranked list of the offerings, wherein the ranked list is viewable at plural user devices within the enterprise, and the offerings comprise at least one selected from the group consisting of: sales offerings; service offerings; and serviceability offerings;
program instructions to receive an input, from one of the user devices, to link an item to one of the offerings included in the ranked list;
program instructions to access stored cost/benefit data defined for the item;
program instructions to update a score of the one of the offerings based on the cost/benefit data defined for the item; and
program instructions to update the ranked list based on the updated score,
wherein the program instructions are stored on the computer readable storage medium for execution by the CPU via the computer readable memory.

13. The system of claim 12, wherein the cost/benefit data includes at least one selected from the group consisting of: development cost; testing cost; delivery cost; servicing/warranty cost; post-sale debugging cost; revenue; usable life; discounts; and ancillary business benefits.

14. The system of claim 12, further comprising:
program instructions to receive input to create a new offering;
program instructions to determine a score of the new offering based on cost/benefit data of at least one item; and
program instructions to update the ranked list to include the new offering.

15. The system of claim 12, further comprising:
program instructions to automatically identify an additional item to link to the one of the offerings based on a classification code or category;
program instructions to access stored cost/benefit data defined for the additional item;
program instructions to update the score of the one of the offerings based on the cost/benefit data defined for the additional item; and
program instructions to update the ranked list based on the updating the score of the one of the offerings based on the cost/benefit data defined for the additional item.

16. The system of claim 12, wherein the input is received via an API call from the one of the user devices to the server running the decision analysis tool.

17. The system of claim 12, further comprising program instructions to transmit data defining the updated ranked list to the plural user devices.

18. The system of claim 12, further comprising program instructions to receive the cost/benefit data defined for the item from the one of the user devices.

19. A computer program product for managing allocation of resources among plural offerings in order to determine a priority of development of the offerings, the computer program product comprising a computer readable storage medium having program instructions embodied therewith, the program instructions executable by a computing device to cause the computing device to:
maintain a ranked list of the offerings, wherein the ranked list is viewable at plural user devices within the enterprise, and the offerings comprise at least one selected from the group consisting of: sales offerings; service offerings; and serviceability offerings;
link an item to one of the offerings included in the ranked list, wherein the item is one of: a sales item; a service item; and a serviceability item;
access stored data defined for the item;
update a score of the one of the offerings based on the data defined for the item;
update the ranked list based on the updated score; and
transmit data defining the updated ranked list to one of the plural user devices.

20. The computer program product of claim 19, wherein the program instructions cause the computing device to:
automatically identify an additional item to link to the one of the offerings based on a classification code or category;
access stored data defined for the additional item;
update the score of the one of the offerings based on the data defined for the additional item; and
update the ranked list based on the updating the score of the one of the offerings based on the cost/benefit data defined for the additional item.
